(19) United States
(12) Patent Application Publication
(10) Pub. No.: US 2009/0193462 A1
(43) Pub. Date: Jul. 30, 2009

(54) APPARATUS AND METHOD FOR TRANSMITTING/RECEIVING ELECTRONIC SERVICE GUIDE IN DIGITAL VIDEO BROADCASTING SYSTEM

(75) Inventors: Hyun-Chul KIM, Suwon-si (KR); Young-Jip Kim, Suwon-si (KR); Byoung-Dai Lee, Seongnam-si (KR); Young-Kyu Bae, Bucheon-si (KR); Ji-Wuck Jung, Suwon-si (KR); Sun-Mi Kim, Seoul (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Gyeonggi-do (KR)

(21) Appl. No.: 12/351,459

(22) Filed: Jan. 9, 2009

(30) Foreign Application Priority Data
Jan. 9, 2008 (KR) 10-2008-0002778

(51) Int. Cl. H04N 5/445

(52) U.S. Cl. 725/39

(57) ABSTRACT

Provided is an apparatus and a method for transmitting/receiving Electronic Service Guide (ESG) data in a digital video broadcasting system. The method includes creating ESG data bursts by grouping ESG data supporting a plurality of languages for each ESG support language; establishing sessions corresponding to respective ESG data bursts; creating ESG setting data including session information and ESG grouping criteria information, the session information including Internet Protocol (IP) addresses and port numbers corresponding to the entire sessions, respectively, the ESG grouping criteria information indicating that the ESG data bursts are grouped for each ESG support language; and broadcasting the ESG setting data via a specific session and broadcasting the ESG data bursts via the established sessions.

### PRIORITY

This application claims priority under 35 U.S.C. § 119(a) to an application entitled “Apparatus and Method for Transmitting/Receiving Electronic Service Guide in Digital Video Broadcasting System” filed in the Korean Industrial Property Office on Jan. 9, 2008 and assigned Serial No. 2008-2778, the contents of which are incorporated herein by reference.

### BACKGROUND OF THE INVENTION

1. Field of the Invention

The present invention relates to an apparatus and a method for transmitting/receiving ESG (Electronic Service Guide) data in a digital video broadcasting system.

2. Description of the Related Art

As a result of recent developments in communication and broadcasting technologies, broadcasting systems and mobile communication systems are currently providing digital mobile broadcasting services, which are evolving from conventional broadcasting services, which provide only sounds and images to more advanced broadcasting services providing packet data together with sounds and images.

Various standards have been proposed in connection with digital mobile broadcasting, and three digital mobile broadcasting standards are currently widely used on a global scale. The first standard is DMB (Digital Multimedia Broadcasting), which has been adopted as the digital mobile broadcasting standard in Korea; the second is DVB-H (Digital Video Broadcasting-Hand Held), which is expected to be adopted as a standard in Europe; and the third standard is MediaFLO, which has been developed by Qualcomm Inc., USA.

Among the digital mobile broadcasting standards, DVB-H is based on DVB (Digital Video Broadcasting), an existing European digital broadcasting standard, and refers to a digital mobile broadcasting standard constructed based on the MPEG (Motion Picture Experts Group)-2 System. Digital broadcasting devices in DVB-H systems transmit ESG data, which includes service description information, service accounting information, and service reception information, and terminals receive services desired by users by using the ESG data.

The ESG data consists of a number of ESG fragments. Current digital broadcasting devices group ESG fragments on the basis of time, genre, or business provider, and provide the grouped ESG fragments. Alternatively, EGS fragments related to a specific service are solely grouped and provided.

Therefore, in order to provide ESG data supporting a plurality of languages, digital broadcasting devices broadcast first ESG data supporting a specific language and second ESG data supporting a language different from the language of the first ESG data. Terminals receive broadcast first and second ESG data, and detect and store only ESG data that corresponds to the language desired by users of the terminals.

As such, conventional digital broadcasting devices have a problem in that, since they are not adapted to group and provide ESG fragments for each ESG support language, they cannot transmit only ESG data supporting a specific language to terminals.

In addition, each terminal must receive ESG data supporting various languages in order to receive ESG data corresponding to a language desired by a user of the terminal. Therefore, at least a predetermined period of time is required to receive ESG data in this manner.

### SUMMARY OF THE INVENTION

Accordingly, the present invention has been made to solve the above-mentioned problems occurring in the prior art, and the present invention provides an apparatus and a method for enabling a digital broadcasting device to group ESG (Electronic Service Guide) fragments for each ESG support language and provide the fragments.

The present invention also provides an apparatus and a method for enabling a terminal to receive an ESG fragment corresponding to a language desired by the user.

In accordance with an aspect of the present invention, there is provided a method for transmitting an ESG (Electronic Service Guide) by a digital broadcasting device in a digital video broadcasting system, the method including creating ESG data bursts by grouping ESG data supporting a plurality of languages for each ESG support language; establishing sessions corresponding to respective ESG data bursts; creating ESG setting data including session information and ESG grouping criteria information, the session information including IP (Internet Protocol) addresses and port numbers corresponding to the entire sessions, respectively, the ESG grouping criteria information indicating that the ESG data bursts are grouped for each ESG support language; and broadcasting the ESG setting data via a specific session and broadcasting the ESG data bursts via the established sessions.

In accordance with another aspect of the present invention, there is provided a method for receiving an ESG by a terminal in a digital video broadcasting system, the method including designating an ESG support language by a user; receiving ESG setting data including session information and ESG grouping criteria information from a digital broadcasting device, the session information indicating IP addresses and port numbers corresponding to entire sessions, the ESG grouping criteria information indicating that ESG data bursts are grouped for each ESG support language; identifying a session used to broadcast a specific ESG data burst supporting a language identical to the designated ESG support language by analyzing the ESG setting data; and receiving the specific ESG data burst via the identified session and storing the received ESG data burst.

In accordance with another aspect of the present invention, there is provided a method for transmitting an ESG by a digital broadcasting device in a digital video broadcasting system, the method including receiving an ESG transmission request message from a terminal via an Internet communication network, the message requesting a transmission of an ESG data burst supporting a specific language, and analyzing the received ESG transmission request message to identify the specific language; retrieving an ESG data burst supporting the identified specific language from pre-stored ESG data supporting a plurality of languages; and transmitting the retrieved ESG data burst to the terminal via the Internet communication network.

In accordance with another aspect of the present invention, there is provided a method for receiving an ESG by a terminal in a digital video broadcasting system, the method including designating an ESG support language by a user; creating an ESG transmission request message requesting a transmission of an ESG data burst supporting a language identical to the designated ESG support language; transmitting the created ESG transmission request message to a digital broadcasting device via an Internet communication network; and receiving and storing the ESG data burst from the digital broadcasting device via the Internet communication network in response to the transmitted ESG transmission request message.

In accordance with another aspect of the present invention, there is provided an apparatus for transmitting an ESG by a digital broadcasting device in a digital video broadcasting system, the apparatus including an ESG setting unit for creating ESG data bursts by grouping ESG data supporting a plurality of languages for each ESG support language, establishing sessions corresponding to respective ESG data bursts, and creating ESG setting data including session information and ESG grouping criteria information, the session information including IP addresses and port numbers corresponding to the established sessions, the ESG grouping criteria information indicating that the ESG data bursts are grouped for each ESG support language; an encapsulation unit for encapsulating the ESG data bursts and the ESG setting data; a multiplexing unit for creating a transport stream by using the encapsulated ESG data bursts and the encapsulated ESG setting data according to the established sessions; and a modulation unit for receiving an input of the transport stream and broadcasting the transport stream.

In accordance with another aspect of the present invention, there is provided an apparatus for receiving an ESG by a terminal in a digital video broadcasting system, the apparatus including a memory unit; a wireless unit; and a control unit for designating an ESG support language by a user, receiving ESG setting data from a digital broadcasting device by using the wireless unit, the ESG setting data including session information and ESG grouping criteria information, the session information indicating IP addresses and port numbers corresponding to entire sessions, respectively, the ESG grouping criteria information indicating that ESG data bursts are grouped for each ESG support language, analyzing the received ESG setting data to identify a session used to broadcast a specific ESG data burst supporting a language identical to the designated ESG support language, receiving the specific ESG data burst via the identified session, and storing the received ESG data burst in the memory unit.

In accordance with another aspect of the present invention, there is provided an apparatus for transmitting an ESG by a digital broadcasting device in a digital video broadcasting system, the apparatus including a wireless unit for communicating with a terminal via an Internet communication network; an ESG storage unit for storing ESG data supporting a plurality of languages; and an ESG selection unit for receiving an ESG transmission request message via the wireless unit, the message requesting a transmission of ESG data bursts supporting a specific language, analyzing the received ESG transmission request message to identify the specific language, retrieving an ESG data burst supporting the identified specific language from the ESG data, and transmitting the retrieved ESG data burst to the terminal via the wireless unit.

In accordance with another aspect of the present invention, there is provided an apparatus for receiving an ESG by a terminal in a digital video broadcasting system, the apparatus including a wireless unit for communicating with a digital broadcasting device via an Internet communication network; a memory unit; and a control unit for designating an ESG support language by a user, creating an ESG transmission request message for requesting a transmission of ESG data bursts supporting a language identical to the designated ESG support language, transmitting the created ESG transmission request message to the digital broadcasting device via the wireless unit, receiving ESG data bursts from the digital broadcasting device via the wireless unit in response to the transmitted message, and storing the received ESG data bursts in the memory unit.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates the construction of a digital video broadcasting system according to an embodiment of the present invention;

FIG. 2 is a block diagram illustrating the construction of a digital broadcasting device according to an embodiment of the present invention;

FIG. 3 is a block diagram illustrating the construction of a terminal according to an embodiment of the present invention;

FIG. 4 illustrates an exemplary process of broadcasting ESG data by a digital broadcasting device according to a first embodiment of the present invention;

FIG. 5 illustrates the construction of a partition declaration according to the first embodiment of the present invention;

FIG. 6 illustrates the meaning of field_identifier values according to the first embodiment of the present invention;

FIG. 7 illustrates the meaning of field_encoding values according to the first embodiment of the present invention;

FIG. 8 illustrates the meaning of encoding types according to the first embodiment of the present invention;

FIG. 9 illustrates an exemplary process of broadcasting ESG data by a digital broadcasting device according to a second embodiment of the present invention;

FIG. 10 illustrates the construction of a ServiceGuideDeliveryDescriptor element according to the second embodiment of the present invention;

FIG. 11 illustrates the construction of a GroupingCriteriaType element according to the second embodiment of the present invention;

FIG. 12 illustrates the construction of a FragmentType element according to the second embodiment of the present invention;

FIG. 13 illustrates a key-value pair format according to an embodiment of the present invention;

FIG. 14 is a flowchart illustrating steps of providing ESG data via a broadcasting communication network in a digital video broadcasting system according to an embodiment of the present invention;

FIG. 15 is a flowchart illustrating steps of receiving ESG data by a terminal according to the first embodiment of the present invention;

FIG. 16 is a flowchart illustrating steps of receiving ESG data by a terminal according to the second embodiment of the present invention; and

FIG. 17 is a flowchart illustrating steps of providing ESG data via an Internet communication network in a digital video broadcasting system according to an embodiment of the present invention.

### DETAILED DESCRIPTION OF THE EXEMPLARY EMBODIMENT

Hereinafter, exemplary embodiments of the present invention will be described with reference to the accompanying drawings. In the following description, the same elements will be designated by the same reference numerals when the same elements are shown in different drawings. Further, in the following description of the present invention, a detailed description of known functions and configurations incorporated herein will be omit when it may make the subject matter of the present invention rather unclear.

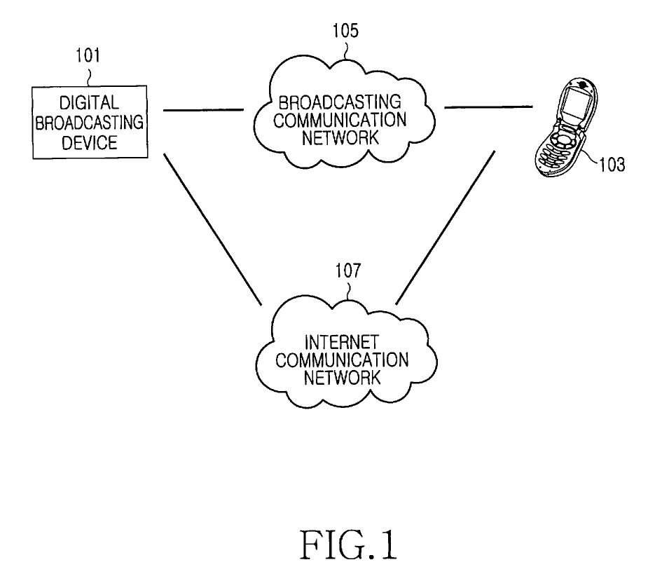

FIG. 1 is a block diagram illustrating the construction of a DVB-H system according to an embodiment of the present invention. Components of the DVB-H system according to the present invention will now be described with reference to FIG. 1.

Referring to FIG. 1, the DVB-H system includes a digital broadcasting device 101, a terminal 103, a broadcasting communication network 105 between the digital broadcasting device 101 and the terminal 103, and an Internet communication network 107 between the digital broadcasting device 101 and the terminal 103.

The digital broadcasting device 101 creates and broadcasts a TS (Transport Stream). Particularly, the digital broadcasting device according to the present invention classifies ESG data for each ESG support language, creates ESG data bursts, and broadcasts the created ESG data bursts via the broadcasting communication network 105. The digital broadcasting device 101 stores ESG data bursts, which have been classified according to each ESG support language. Upon receiving an ESG data transmission request message, which includes specific ESG support language information from the terminal via the Internet communication network 107, the digital broadcasting device 101 analyzes the ESG data transmission request message and retrieves the ESG support language information. The digital broadcasting device 101 detects an ESG data burst supporting the same language as the retrieved ESG support language information, and transmits the detected ESG data burst to the terminal via the Internet communication network 107, which may be an HTTP (HyperText Transfer Protocol)/1.1 communication network.

As used herein, the term “ESG support language information” refers to information regarding an ESG support language requested by the user, and the term “ESG support language” refers to a language supported by ESG data bursts.

The terminal 103 receives the broadcast TS and provides the user with a broadcasting service. Particularly, the terminal 103 according to the present invention receives and stores an ESG data burst, which supports the language desired by the user, among the ESG data bursts which have been classified for each ESG support language and broadcast. The terminal 103 creates and transmits an ESG data transmission request message, which includes specific ESG support language information, to the digital broadcasting device 101 via the Internet communication network 107. The terminal 103 receives and stores an ESG data burst corresponding to the ESG support language information from the digital broadcasting device 101 as a response.

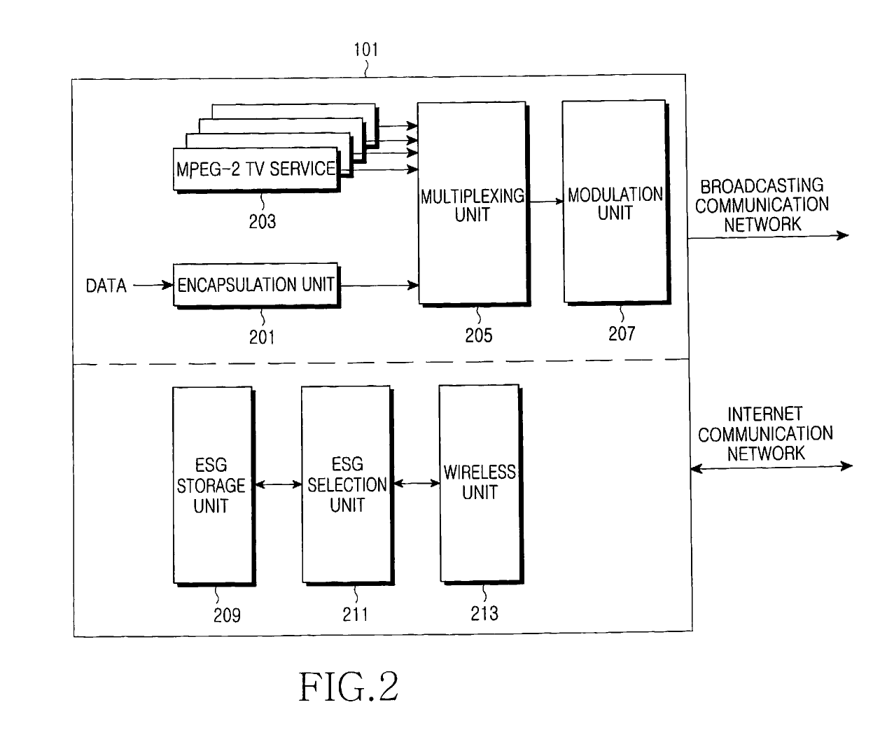

FIG. 2 is a block diagram illustrating the construction of a digital broadcasting device 101 according to an embodiment of the present invention. Components of the digital broadcasting device 101 according to the present invention will now be described with reference to FIGS. 1 and 2.

Referring to FIG. 2, an ESG setting unit (not shown) and the digital broadcasting device 101 include an encapsulation unit 201, MPEG-2 TV services 203, a multiplexing unit 205, a modulation unit 207, an ESG storage unit 209, an ESG selection unit 211, and a wireless unit 213. The encapsulation unit 201, the MPEG-2 TV services 203, the multiplexing unit 205, and the modulation unit 207 are devices for broadcasting a TS via the broadcasting communication network 105. The ESG storage unit 209, the ESG selection unit 211, and the wireless unit 213 are devices for transmitting ESG data via the Internet communication network 107.

The encapsulation unit 201 receives an input of content data from a server, to which an IP (Internet Protocol) address has been assigned, and encapsulates the content data according to the IP address of the server that has provided the content data. Particularly, the encapsulation unit 201 according to the present invention receives an input of ESG data, classifies the ESG data for each support language to create ESG data bursts, assigns different IP addresses to the respective created ESG data bursts, and encapsulates the created ESG data bursts according to the assigned IP addresses, respectively, to create data packets.

The multiplexing unit 205 creates a TS by using data packets input from the encapsulation unit 203 and the stream-type MPEG-2 TV services 203. Particularly, the multiplexing unit 205 receives an input of ESG data packets, establishes a session based on the IP address, and assigns ESG data packets that support the same language to the same session.

The modulation unit 207 converts the TS input from the multiplexing unit 205 into an analog TS, amplifies the analog TS based on the frequency assigned to the digital broadcasting service, and broadcasts the amplified TS via the broadcasting communication network 105.

The ESG setting unit (not shown) creates ESG setting data by reflecting sessions established for respective ESG data bursts classified for each ESG support language. Then, the ESG setting unit outputs the created ESG setting data to the encapsulation unit 201. The ESG setting data includes ESG grouping criteria information, which indicates he manner in which ESG data bursts are grouped for each ESG support language, and session information including IP addresses and port numbers corresponding to entire sessions, respectively.

As used herein, the term “digital broadcasting service” refers to a digital service supported by a DVB-H system, particularly a service for providing digital TV broadcasts, radio broadcasts, and contents supported by content providers (e.g. moving pictures, images, games). The TS includes ESG data bursts and content data bursts for providing a digital broadcasting service, and is divided into a number of sessions, to which different IP addresses and port numbers (referred to as session information as a whole) are assigned.

The ESG storage unit 209 stores ESG data bursts classified for each ESG support language. The wireless unit 213 communicates with the terminal 103 via the Internet communication network 107. Particularly, upon receiving an ESG data transmission request message from the terminal 103, the wireless unit 103 according to the present invention outputs the received ESG data transmission request message to the ESG selection unit 211. Upon receiving an input of an ESG data burst from the ESG selection unit 211, the wireless unit 213 transmits the input ESG data burst to the terminal 103.

The ESG selection unit 211 analyzes the ESG data transmission request message input from the wireless unit 213 to retrieve ESG support language information, detects an ESG data burst corresponding to the retrieved ESG support language information from the ESG storage unit 209, and outputs the detected ESG data burst to the wireless unit 213.

DVB-H standards are divided into CBMS (Convergence of Broadcast and Mobile Services) and OMA (Open Mobile Alliance)-BCAST (Mobile Broadcast Services Enabler Suite). CBMS has been pioneered by the Digital Video Broadcast Project and focused is on the IP (Internet Protocol) Datacast of DVB to gain support of broadcast providers. The OMA-BCAST refers to a standard created by OMA, which is a group of experts studying standards for interworking between separate mobile solutions, and has mainly been in charge of determining various application standards regarding mobile games, Internet services, etc. Among working groups including OMA, OMA, and BAC (Browser and Content), BCAST (Mobile Broadcast Sub Working Group) has particularly been studying technology for providing broadcasting services by using mobile terminals.

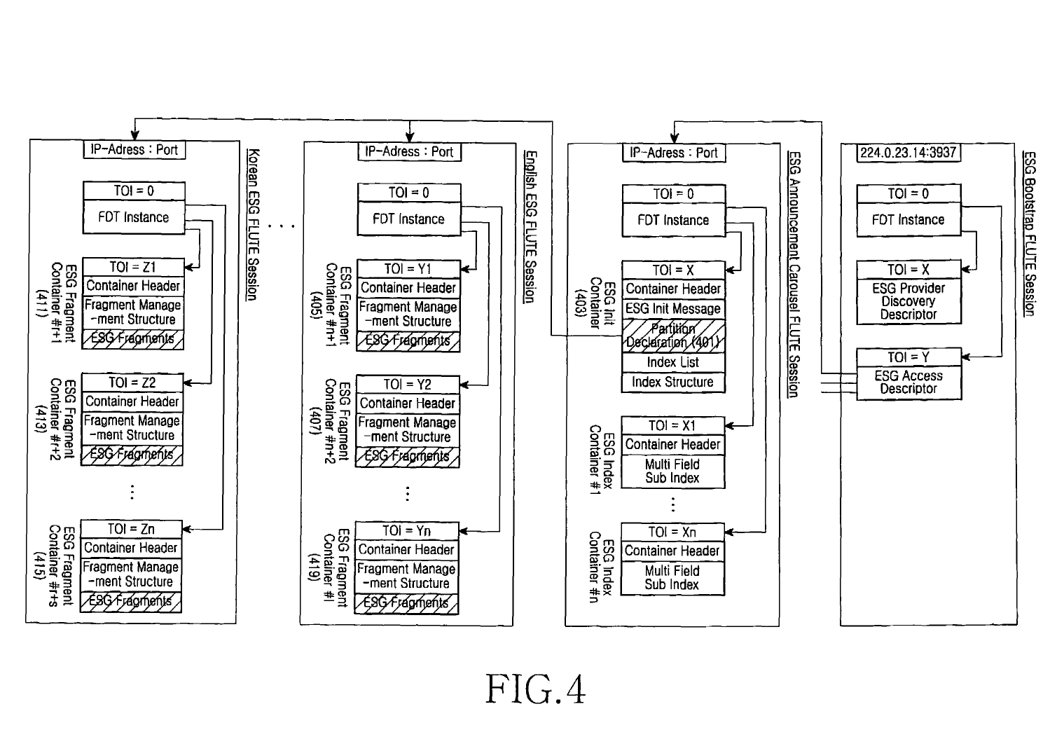

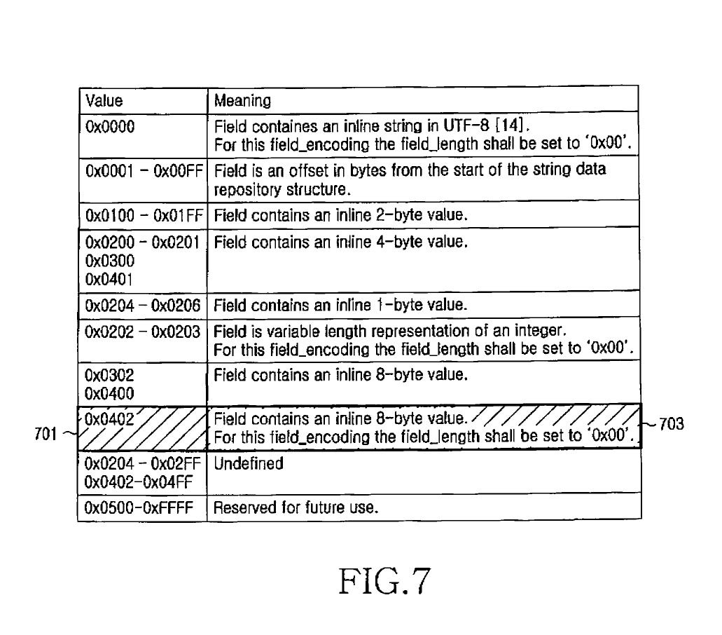

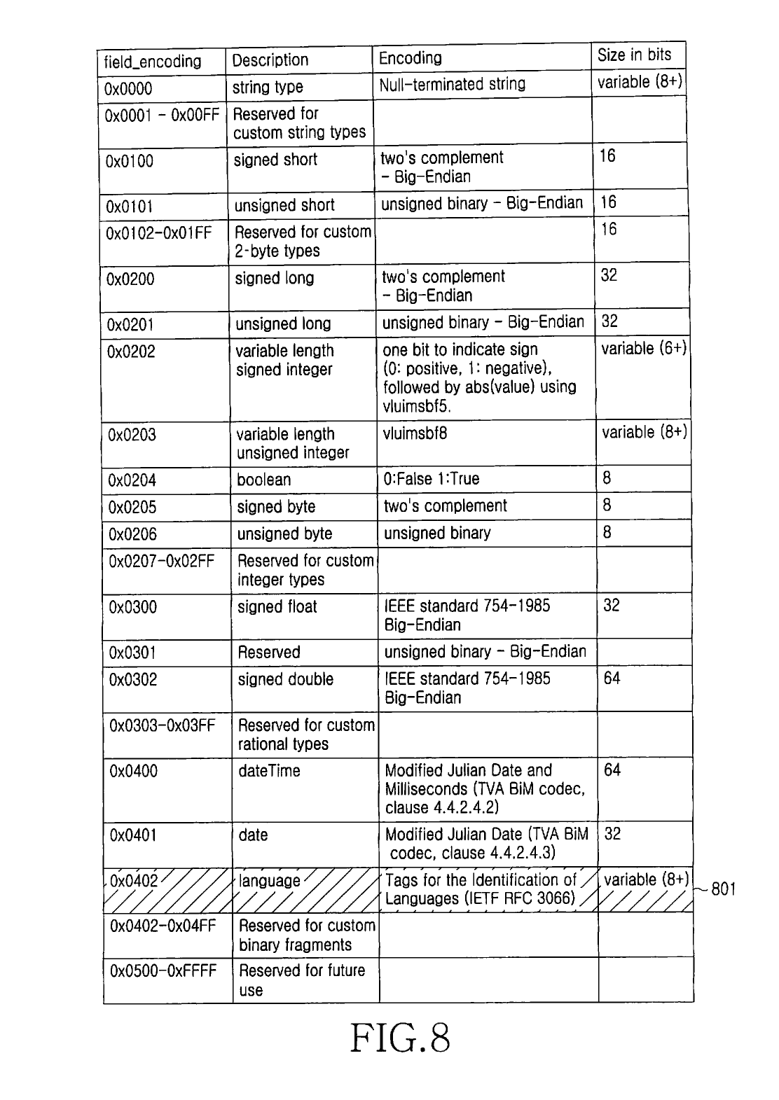

The type of ESG setting data, for example, depends on whether the digital broadcasting device 101 follows either CBMS or OMA-BCAST standards. Operations for creating and broadcasting ESG setting data by a digital broadcasting device 101 following CBMS standards, as well as broadcasting ESG data bursts classified for each support language will now be described with reference to FIGS. 4-12.

FIG. 4 illustrates an exemplary process of broadcasting ESG data bursts and ESG setting data, by a digital broadcasting device, according to a first embodiment of the present invention. In the following description, the digital broadcasting device follows CBMS standards, and that ESG data is grouped for each ESG support language and broadcast. The ESG setting data corresponds to a partition declaration 401.

Each ESG data burst consists of ESG fragments, which are grouped into respective ESG fragment containers and then broadcast. The partition declaration 401 included in the ESG init. container 403 includes session information regarding sessions used to broadcast ESG data bursts, and ESG grouping criteria information indicating that ESG data bursts are grouped according to each ESG support language.

Referring to FIG. 4, the digital broadcasting device 101 classifies ESG data according to each ESG support language to create ESG data bursts, and broadcasts the created ESG data bursts via different sessions, respectively.

In the following example, ESG data bursts support the languages of English and Korean. The digital broadcasting device 101 classifies ESG data bursts supporting English on a basis of ESG corresponding fragment containers and creates ESG fragment container #n+1 405, ESG fragment container #n+2 407, . . . , ESG fragment container #1 409. The digital broadcasting device 101 classifies ESG data bursts supporting Korean on a basis of corresponding ESG fragment containers and creates ESG fragment container #r+1 411, ESG fragment container #r+2 413, . . . , ESG fragment container #r+s 415. Then, the digital broadcasting device 101 broadcasts ESG fragment container #n+1 405, ESG fragment container #n+2 407, . . . , ESG fragment container #1 409, which support the same language, via the same session. In addition, the digital broadcasting device 101 broadcasts ESG fragment container #r+1 411, ESG fragment container #r+2 413, . . . , ESG fragment container #r+s 415, which support the same language, via the same session.

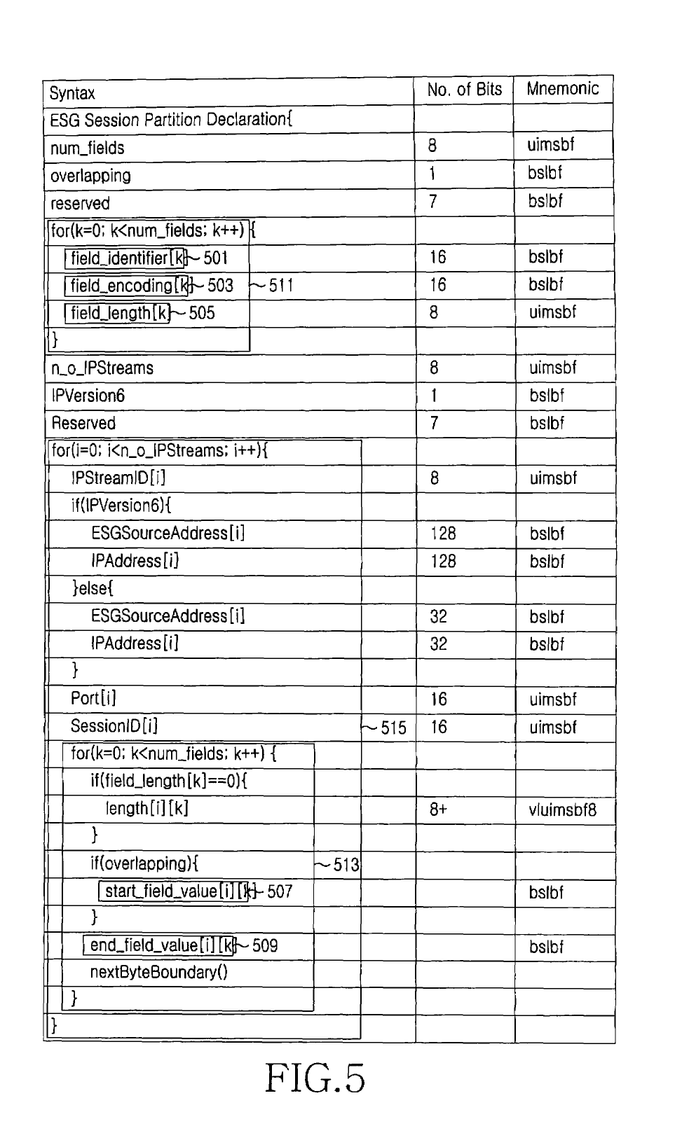

Referring to FIG. 5, the partition declaration 401 includes session information corresponding to each of i sessions in the session portion 515 included in the partition declaration 401. Each session includes k fields, and field portions 511 and 513 include ESG grouping criteria information corresponding to each of k fields. To be more specific, the ESG grouping criteria information includes ESG classification information and ESG support language information. The field portion 511 includes ESG classification information indicating that ESG data bursts are grouped according to each ESG support language. The field portion 513 includes ESG support language information indicating the language supported by each ESG data burst broadcast during a specific session.

The ESG classification information includes a field_identifier 501, a field_encoding 503, and a field_length 505. The ESG support language information includes a start_field_value 507 and an end_field_value 509.

FIGS. 5-8 illustrate the field_identifier 501 values, the field_encoding 503 values, encoding types, and corresponding field_encoding sizes according to an embodiment of the present invention.

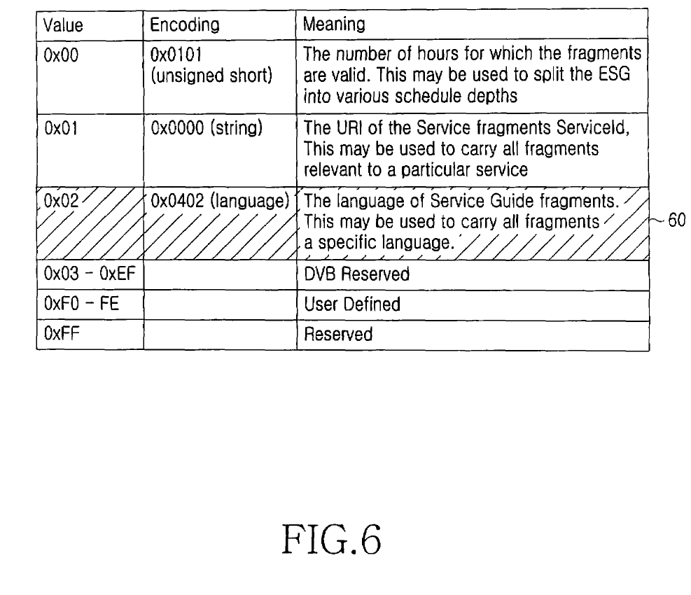

Referring to FIGS. 6-8, when ESG data bursts grouped according to a specific language are broadcast during a specific session, the field_identifier 501, field_encoding 503, and field_length 505, existing in a specific field portion 511, within a specific session portion 515 may have values set as 0×00 601, 0×402 701, and 0×00 703, respectively. The value of the start_field_value 507 and end_field_value 508 may be set as a tag 801 indicating a specific language. For example, a language tag defined according to IETF RFC 3066 may be used as the tag 801.

As mentioned above, the digital broadcasting device 101 following CBMS standards can group ESG data for each ESG support language and broadcast grouped ESG data bursts via different sessions, respectively.

In order to indicate that ESG data bursts are broadcast with regard to each ESG support language, the digital broadcasting device 101 searches a specific session portion 515, which corresponds to respective sessions used to broadcast ESG data bursts classified for each ESG support language, among i session portions 515 included in the partition declaration 401, which is ESG setting data. Then, the digital broadcasting device 101 assigns values of 0×00 601, 0×402 701, and 0×00 701 to the field_identifier 501, field_encoding 503, and field_length 505 positioned within specific field portions 511 and 513 among a number of field portions included in the searched session portion 515, and designates the value of start_field_value 507 and end_field_value 509 as a tag 801 indicating the language supported by the ESG data bursts included in the corresponding session. The digital broadcasting device 101 can now broadcast the partition declaration 401.

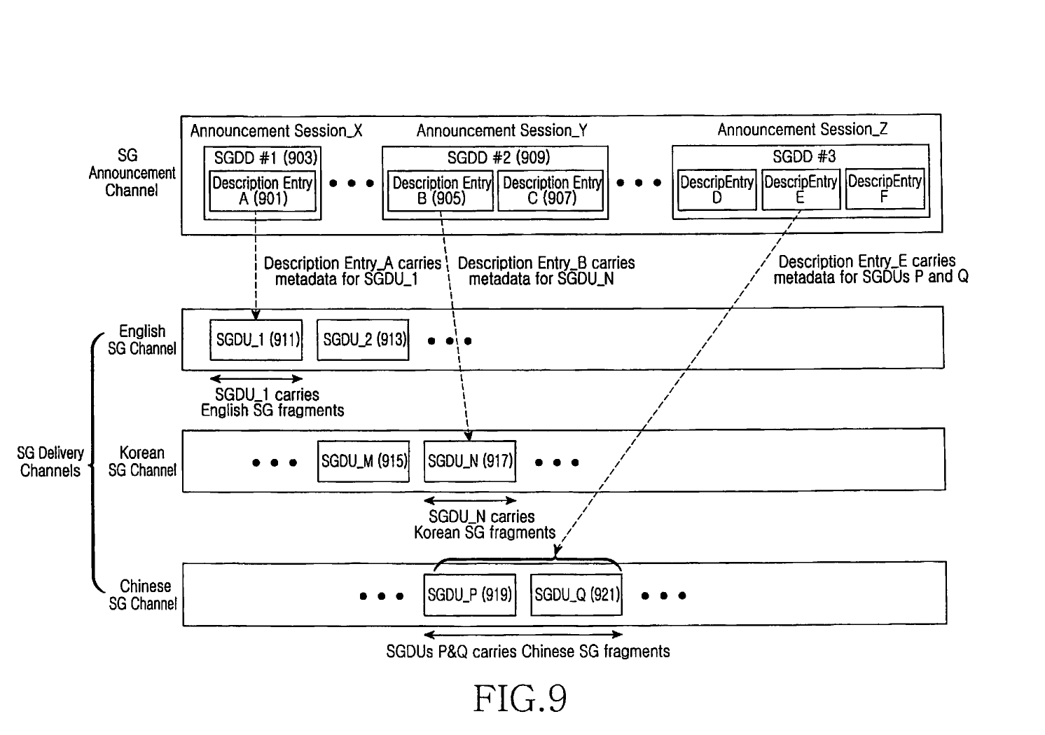

FIG. 9 illustrates an exemplary process of broadcasting ESG data by a digital broadcasting device 101 according to a second embodiment of the present invention. It will be assumed in the following description that the digital broadcasting device 101 follows OMA-BCAST standards, and that ESG data bursts are grouped for each ESG support language and broadcast. In this case, the ESG setting data becomes a DescriptionEntry.

ESG fragments constituting each ESG data burst are grouped into a SGDU (Service Guide Delivery Unit) and broadcast, and DescriptionEntries are grouped into a SGDD (Service Guide Delivery Descriptor) and broadcast.

The SG announcement channel broadcasts a number of SGDDs 903 and 909, and the DescriptionEntry of a specific SGDD includes session information regarding the corresponding session and ESG grouping criteria information regarding SGDUs included in the corresponding session. For example, DescriptionEntry A 901 included in SGDD #1 903 includes session information regarding a session used to broadcast SGDU_{—}1 911 and SGDU_{—}2 913 and EGS grouping criteria information.

Each SG delivery channel broadcasts SGDUs classified for each ESG support language. To be more specific, the English SG channel broadcasts SGDU_{—}1 911 and SGDU_{—}2 913 consisting of ESG fragments that support English; the Korean SG channel broadcasts SGDU_M 915 and SGDU_N 917 consisting of ESG fragments that support Korean; and the Chinese SG channel broadcasts SGDU_P 919 and SGDU_Q 921 consisting of ESG fragments that support Chinese.

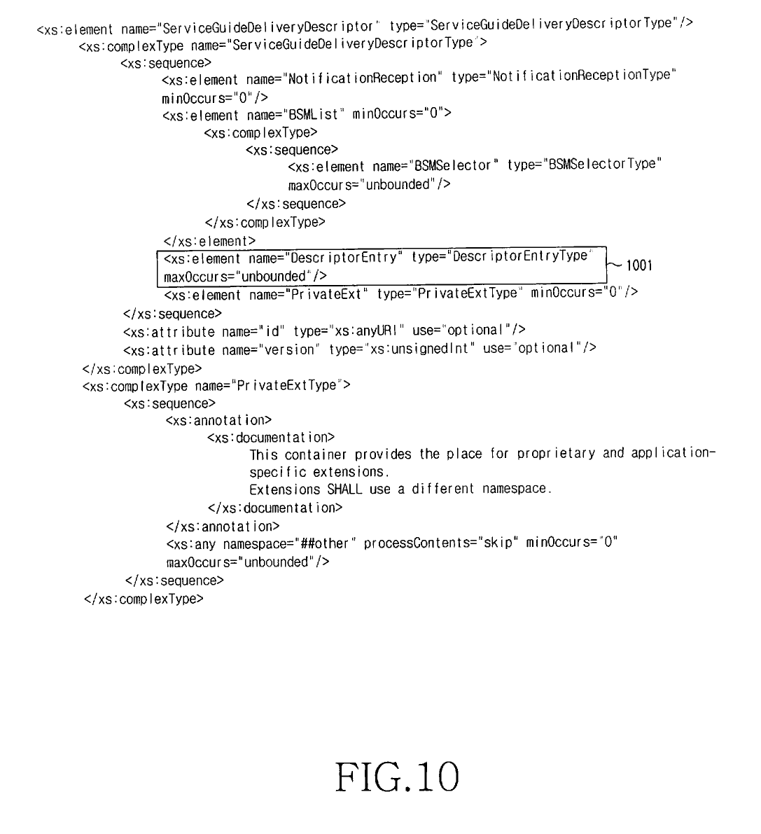

FIGS. 10-12 illustrate an exemplary xml (eXtensible Markup Language) format of an SGDD according to an embodiment of the present invention. Referring to FIG. 10, the ‘ServiceGuideDeliveryDescriptor’ element includes a ‘DescriptorEntry’ element 1001.

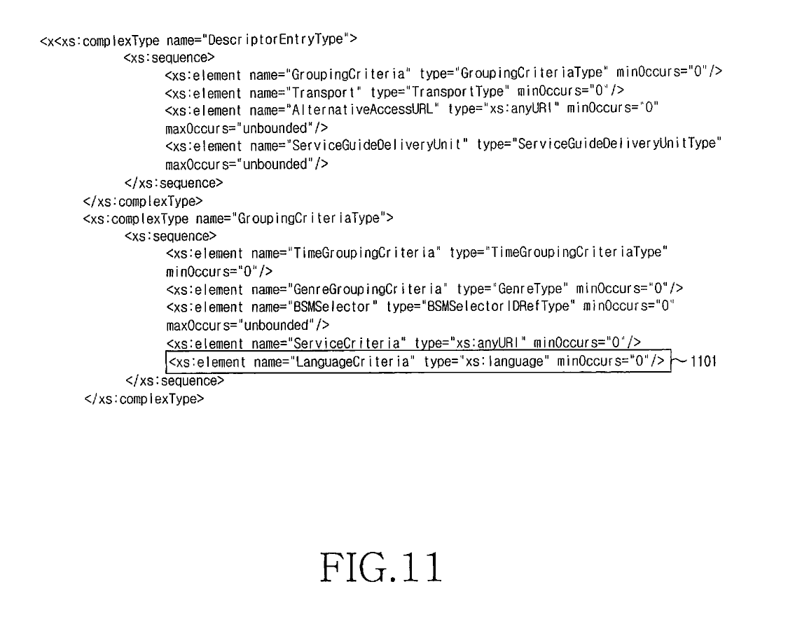

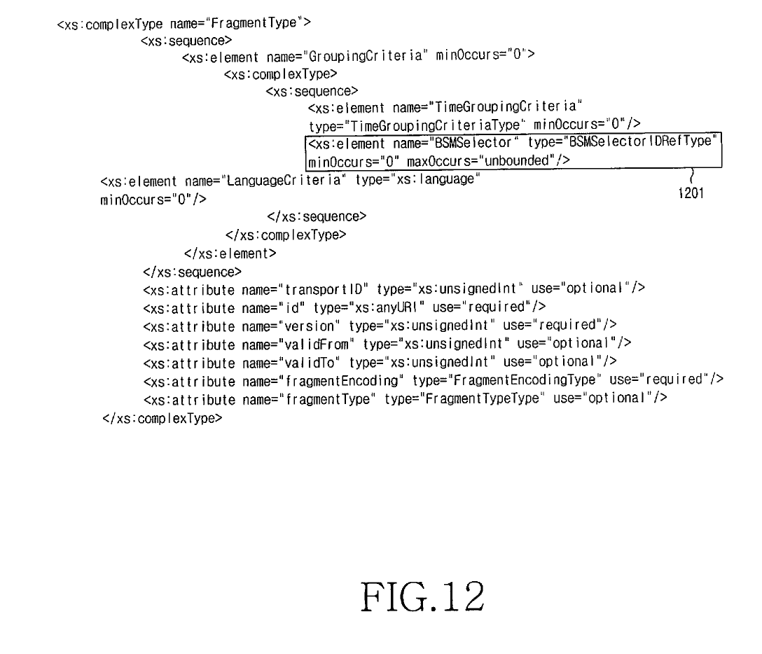

The ‘DescriptorEntry’ element 1001 can define ESG grouping criteria information, which indicates that SGDDs included in the corresponding session are grouped according to each support language, by using a ‘LanguageCriteria’ element. To be more specific, a ‘LanguageCriteria’ element 1101 is added inside the ‘GroupingCriteriaType’ element positioned below the ‘DescriptorEntry’ element 1001, as shown in FIG. 11. In addition, a ‘LanguageCriteria’ element 1201 is added inside the ‘GroupingCriteria’ element positioned below the ‘fragment’ element, which defines the criteria of respective ESG fragments, to define ESG grouping criteria information, as shown in FIG. 12.

As mentioned above, the digital broadcasting device 101 following OMA-BCAST standards classifies ESG data according to each ESG support language to create ESG data bursts, and broadcasts the created ESG data bursts during different sessions.

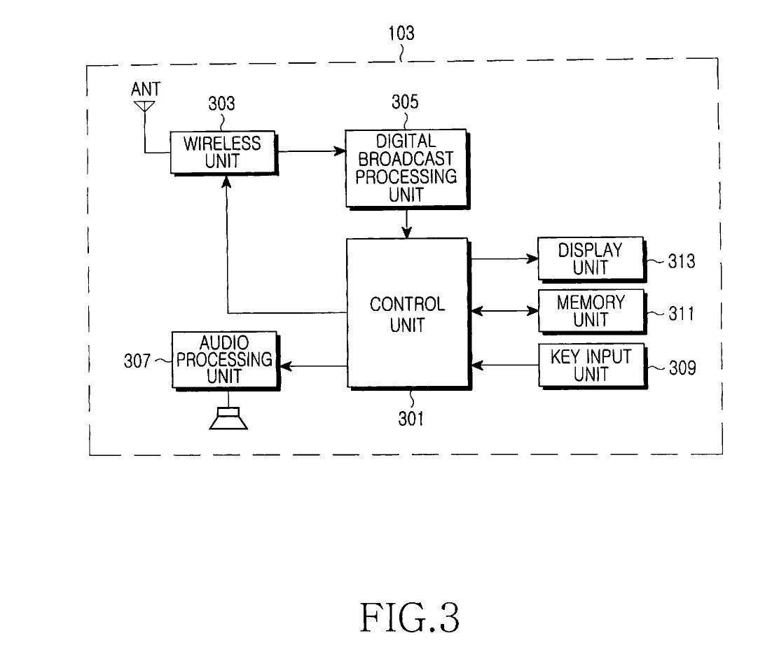

FIG. 3 is a block diagram illustrating the construction of a terminal according to an embodiment of the present invention. Components of the terminal according to the present invention will now be described with reference to FIG. 3.

Referring to FIG. 3, the terminal 103 includes a control unit 301, a wireless unit 303, a digital broadcast processing unit 305, an audio processing unit 307, a key input unit 309, a memory unit 311, and a display unit 313.

The wireless unit 303 receives a TS signal broadcast from the digital broadcasting device 101 via the broadcasting communication network 105, or transmits/receives specific data via the Internet communication network 107. The digital broadcast processing unit 305 receives the TS signal input from the wireless unit 303, decodes the TS signal into digital data of a baseband signal, and applies the decoded digital data to the control unit 301.

The audio processing unit 307 converts audio signals output by the control unit 301 into audible sounds and outputs the audible sounds. The key input unit 309 consists of numeric keys (including ‘*’ and ‘#’ keys) for watching digital broadcasts and function keys for various functions such that, when the user presses a key, a corresponding key signal is created and output to the control unit 301.

The memory unit 311 stores data necessary to control the terminal. In particular, the memory unit 311 according to the present invention stores ESG data bursts, which have been broadcast by the digital broadcasting device 101. The display unit 313 displays the current condition and operating condition of the terminal under the control of the control unit 301. In general, an LCD (Liquid Crystal Display) or an OLED (Organic Light Emitting Diode) constitutes the display unit 313.

The control unit 301 controls respective components of the terminal 103 to provide a digital broadcasting service.

Particularly, the control unit 301 according to the present invention designates an ESG support language desired by the user, receives ESG setting data from the digital broadcasting device 101, analyzes the ESG setting data to identify a session used to broadcast ESG data bursts corresponding to the designated ESG support language, and accesses the identified session to receive and store ESG data bursts corresponding to the designated ESG support language.

To be more specific, when the digital broadcasting device 101 provides a digital broadcasting service according to CBMS standards, the digital broadcasting device 101 receives a partition declaration 401, which is ESG setting data, analyzes the partition declaration 401 to find a session, which is used to broadcast ESG data bursts corresponding to the designated ESG support language, among sessions, receives ESG data bursts via the session found, and stores the bursts. When the digital broadcasting device 101 provides a digital broadcasting service according to OMA-BCAST standards, the digital broadcasting device 101 receives DescriptorEntries 901 and 903, which are ESG setting data, analyzes the DescriptorEntries 901 and 903 to find a session, which is used to broadcast ESG data bursts corresponding to the designated ESG support language, among sessions, receives ESG data bursts via the session found, and stores the bursts.

In order to receive ESG data bursts corresponding to the designated ESG support language, the control unit 301 creates ESG support language information indicating the designated ESG support language, creates an ESG transmission request message including the created ESG support language information, and transmits the message to the digital broadcasting device 101 via the Internet communication network 107.

As used herein, the term “ESG transmission request message” refers to a message for requesting a transmission of ESG data corresponding to the designated ESG support language.

When the terminal 103 provides a digital broadcasting service according to OMA-BCAST standards, the ESG transmission request message can define desired ESG criteria by using a key-value pair. Particularly, when the terminal 103 requires an ESG related to a specific service, a specific genre, or a specific time period, a key-value pair may be used to define desired ESG criteria, and an ESG transmission request message including the defied key-value pair can be transmitted to the digital broadcasting device 101.

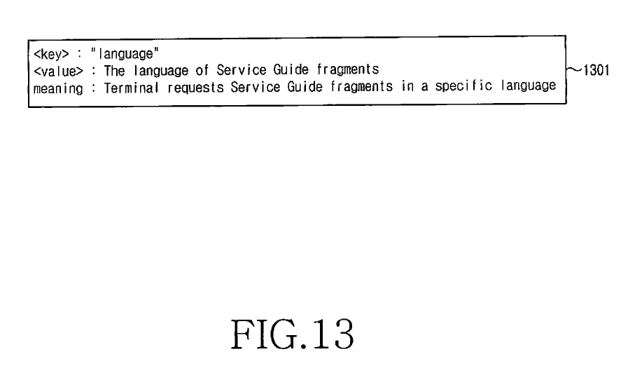

If the terminal 103 wants to receive ESG data corresponding to a preset ESG support language, a key-value pair 1301 as shown in FIG. 13 can be used to define ESG support language information. In this case, <value> can be used to define a language tag corresponding to the preset ESG support language, and the language tag can be defined according to IETF (Internet Engineering Task Force) RFC (Request For Comment) 3066.

As mentioned above, the terminal 103 can receive ESG data corresponding to the preset ESG support language via the broadcasting communication network 105 or via the Internet communication network 105.

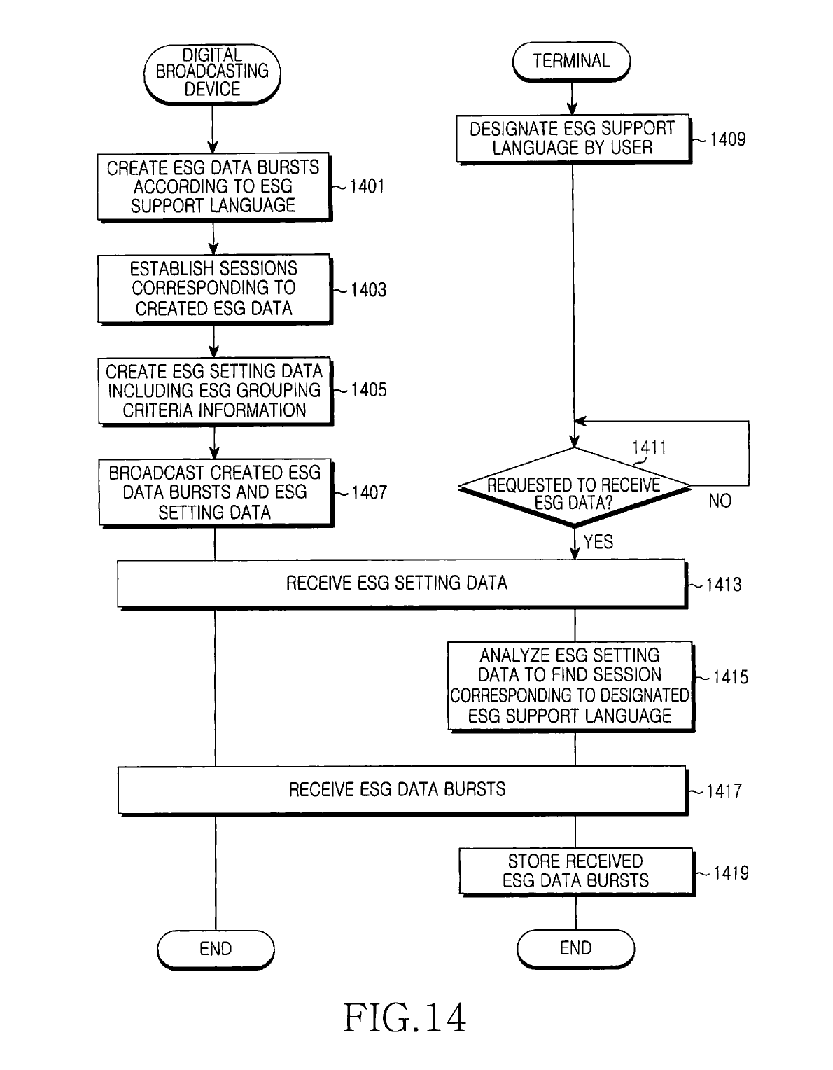

FIG. 14 is a flowchart illustrating steps of providing a terminal 103 with ESG data bursts corresponding to a specific ESG support language via a broadcasting communication network 105 by a digital broadcasting device 101 according to an embodiment of the present invention.

In step 1401, the digital broadcasting device 101 classifies ESG data for each ESG support language to create ESG data bursts. In step 1403, the digital broadcasting device 101 establishes sessions corresponding to respective ESG data bursts, and proceeds to step 1405. In step 1405, the digital broadcasting device 101 creates ESG setting data including session information, which includes information regarding IP addresses and ports corresponding to entire sessions, respectively, and ESG grouping criteria information indicating that the ESG data bursts are grouped for each ESG support language, and proceeds to step 1407.

In step 1407, the digital broadcasting device 101 broadcasts the ESG data bursts via the established ESG sessions, and broadcasts created ESG setting data via a specific session.

In step 1409, the terminal 103 designates an ESG support language desired by the user. If there is a request for the terminal 103 is to receive ESG data in step 1411, the terminal 103 proceeds to step 1413; and, if there is not a request for the terminal 103 or receive ESG data, the terminal 103 repeats step 1411.

Upon proceeding to step 1413, the terminal 103 receives ESG setting data broadcast during a specific session. In step 1415, the terminal 103 analyzes the received ESG setting data to find a session used to broadcast ESG data supporting the same language as the designated ESG support language, and proceeds to step 1417.

In step 1417, the terminal 103 accesses a found session and receives ESG data supporting the same language as the designated ESG support language. In step 1419, the terminal 103 stores the received ESG data.

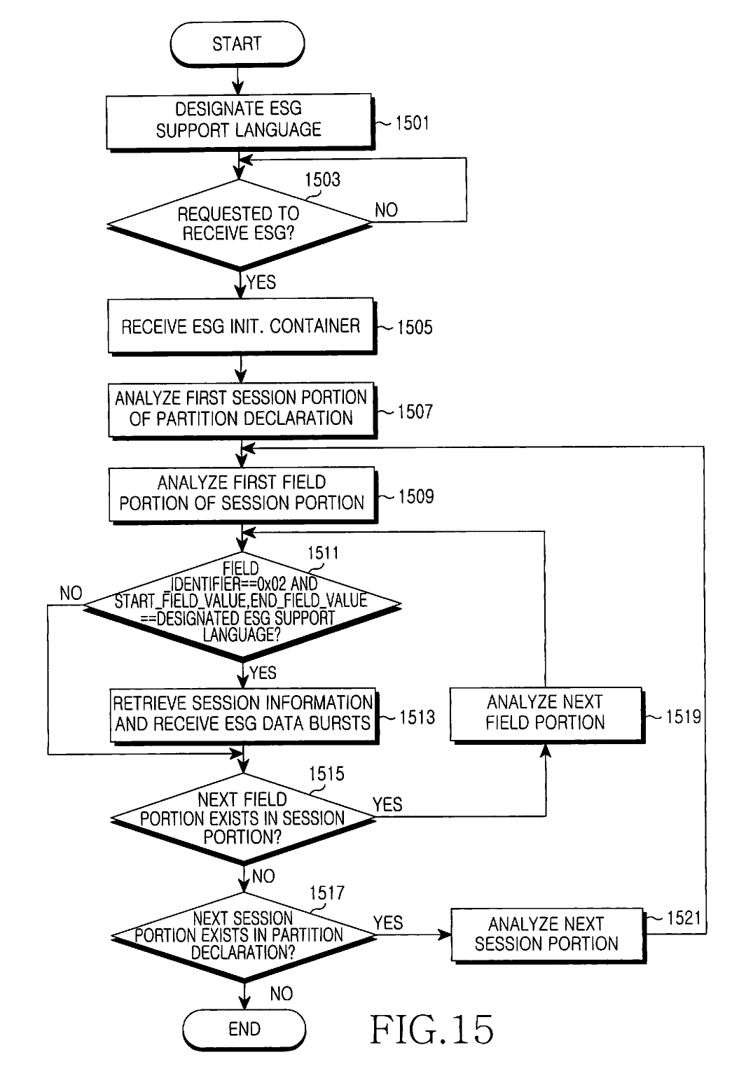

FIG. 15 is a flowchart illustrating a method of receiving ESG data corresponding to a preset ESG support language via the broadcasting communication network 105 by the terminal 103 according to the first embodiment of the present invention. A method of receiving ESG data, which supports a language desired by the user, by the terminal 103, according to the present invention will now be described with reference to FIGS. 1-8.

In the following description, the terminal 103 and the digital broadcasting device 101 provide a digital broadcasting service according to CBMS standards, as an example.

In step 1501, the terminal 103 designates an ESG support language desired by the user. If there is a request for the terminal 103 to receive an ESG in step 1503, the terminal proceeds to step 1505; and, if there is not a request for the terminal 103 to receive and ESG, the terminal 103 repeats step 1503.

Upon proceeding to step 1505, the terminal 103 accesses a specific session and receives an ESG init. container 403. The terminal 103 analyzes the received ESG init. container to detect a partition declaration 401, and proceeds to step 1507. In step 1507, the terminal 103 analyzes the first session portion among a number of session portions defined by the partition declaration 401, and proceeds to step 1509. In step 1509, the terminal 103 analyzes the first field portion among a number of field portions defined by the current session portions that have been analyzed, and proceeds to step 1511.

In step 1511, the terminal 103 determines whether the field_identifier included in the currently analyzed field portion has a value of 0×02 and whether the start_field_value and end_field_value have the same tag value as that of the designated ESG support language. If the field_identifier has a value of 0×02 and if the start_field_value and end_field_value have the same tag value as that of the designated ESG support language, the terminal 103 proceeds to step 1513. In contrast, if the field_identifier does not have a value of 0×02 or if the start_field_value and end_field_value do not have the same tag value as that of the designated ESG support language, the terminal 103 proceeds to step 1515.

Upon proceeding to 1513, the terminal 103 retrieves session information included in the current session portion, accesses the corresponding session by using the retrieved session information to receive ESG data, stores the received ESG data, and proceeds to step 1515. The received ESG data refers to ESG data supporting the same language as the ESG support language designated by the user.

Upon proceeding to step 1515, the terminal 103 determines whether the next field portion exists within the current session portion. If the next field portion exists within the current session portion, the terminal 103 proceeds to step 1519 and analyzes the next field portion. If the next field portion does not exist within the current session portion, the terminal 103 proceeds to step 1517.

Upon proceeding to step 1519, the terminal 103 analyzes the next field portion included in the current session portion, and proceeds to step 1511. Upon proceeding to step 1517, the terminal 103 determines whether the next session portion exists within the partition declaration 401. If the next session portion exists, the terminal 103 proceeds to step 1521. If the next session portion does not exist, the terminal finishes receiving ESG data.

Upon proceeding to step 1521, the terminal 103 analyzes the first session portion of the next session portion, and proceeds to step 1509 to analyze the first field portion within the next session portion.

As such, the terminal 103 following CBMS standards can analyze the partition declaration 401 to identify a session used to broadcast ESG data supporting the same language as the ESG support language designated by the user and access the identified session to receive corresponding ESG data.

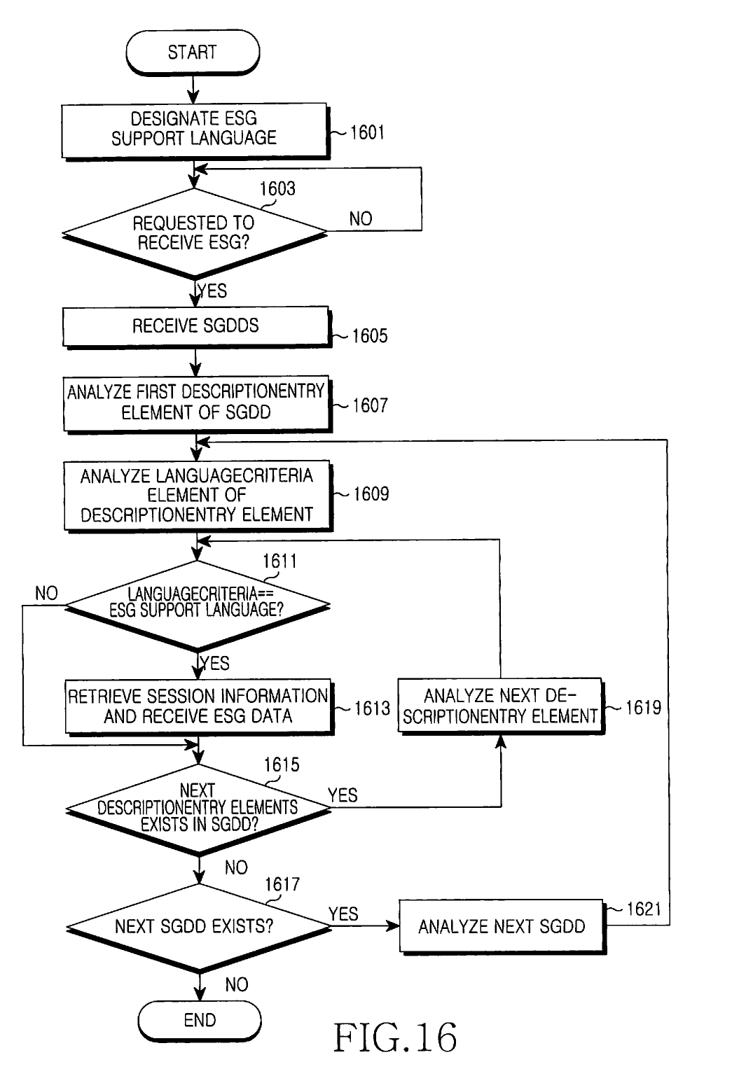

FIG. 16 is a flowchart illustrating a method of receiving ESG data corresponding to a preset ESG support language via the broadcasting communication network 105 by the terminal 103 according to the second embodiment of the present invention. A method of receiving ESG data supporting a language desired by the user by the terminal 103 according to the present invention will now be described with reference to FIGS. 1-3 and 9-12.

In the following description, the terminal 103 and the digital broadcasting device 101 provide a digital broadcasting service according to OMA-BCAST standards, as an example.

In step 1601, the terminal 103 designates an ESG support language desired by the user. In step 1603, if there is a request for the terminal 103 to receive an ESG, the terminal 103 proceeds to step 1605; and, if there is not a request for the terminal 103 to receive an ESG, the terminal 103 repeats step 1603.

Upon proceeding to step 1605, the terminal 103 accesses a specific session and receives SGDDs 903 and 909. Among the received SGDDs 903 and 909, the terminal 103 analyzes the first SGDD 903 to detect at least one DescriptionEntry 901, and proceeds to step 1607. In step 1607, the terminal 103 analyzes the first DescriptionEntry among at least one DescriptionEntry detected from the current SGDD. In step 1609, the terminal 103 analyzes a LanguageCriteria element included in the currently analyzed DescriptionEntry element, and proceeds to step 1611.

In step 1611, the terminal 103 determines whether the analyzed LanguageCriteria element has the same tag value as that of the ESG support language designated by the user. If the analyzed LanguageCriteria element has the same tag value as the tag value of the ESG support language designated by the user, the terminal 103 proceeds to step 1613; and, if the analyzed LanguageCriteria element does not have the same tag value as the tag value of the ESG support language, the terminal 103 proceeds to step 1615.

Upon proceeding to step 1613, the terminal 103 retrieves session information included in the corresponding DescriptionEntry element, accesses the corresponding session by using the retrieved session information to receive ESG data, stores the received ESG data, and proceeds to step 1615. The received ESG data refers to ESG data supporting the same language as the ESG support language designated by the user.

Upon proceeding to step 1615, the terminal 103 determines whether the next DescriptionEntry element exists within the current SGDD. If the next DescriptionEntry element exists within the current SGDD, the terminal 103 proceeds to step 1619; and, if the next DescriptionEntry does not exist within the current SGDD, the terminal 103 proceeds to step 1617. Upon proceeding to step 1619, the terminal 103 analyzes the next DescriptionEntry element and proceeds to step 1609 to analyze the LanguageCriteria element, which is the lower element of the next DescriptionEntry. Upon proceeding to step 1617, the terminal 103 determines whether another SGDD that has been received after the current SGDD among the received SGDDs exists. If SGDD exists, the terminal 103 proceeds to step 1621; and, if no more SGDDs exist, the terminal 103 finishes receiving ESG data.

Upon proceeding to step 1621, the terminal 103 analyzes the next SGDD and proceeds to step 1607 to analyze the first DescriptionEntry within the next SGDD.

As such, the terminal 103 following OMA-BCAST standards can analyze DescriptionEntries 901, 905, and 907 to identify a session used to broadcast ESG data supporting the same language as the ESG support language designated by the user, access the identified session, and receive corresponding ESG data.

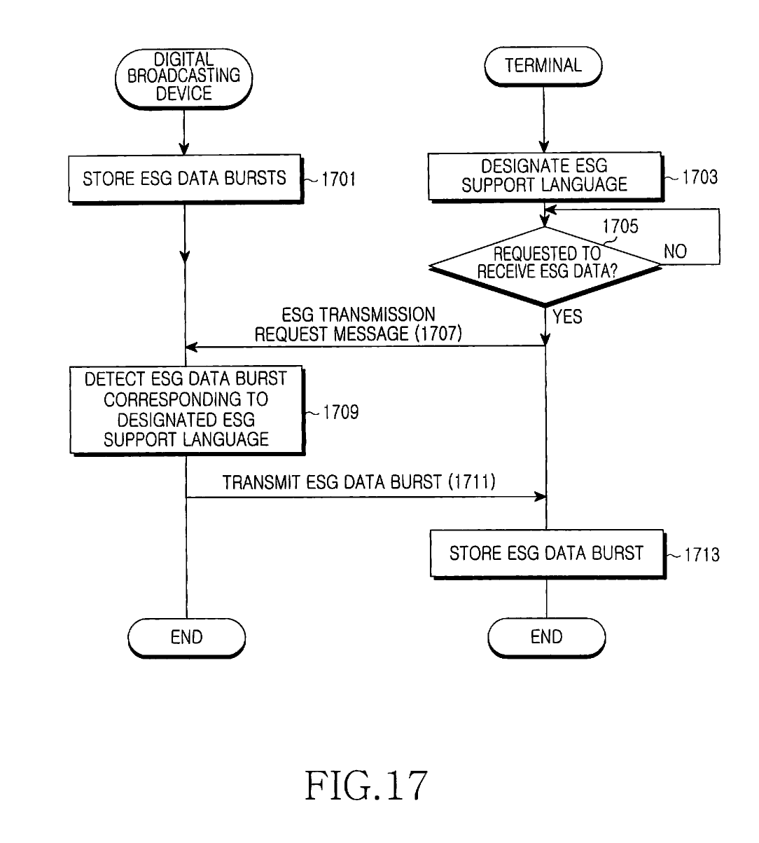

FIG. 17 is a flowchart illustrating a method of providing the terminal 103 with ESG data corresponding to a specific ESG support language via the Internet communication network 107 by the digital video broadcasting device 101 according to an embodiment of the present invention.

In step 1701, the digital broadcasting device 101 periodically stores ESG data as the digital broadcasting service is changed. In step 1703, the terminal 103 designates the ESG support language desired by the user, and proceeds to step 1705.

In step 1705, if there is a request for the terminal 103 is to receive ESG data, the terminal proceeds to step 1707; and, if there is not a request for the terminal 103 to receive ESG data, the terminal repeats step 1705. Upon proceeding to step 1707, the terminal 103 creates an ESG data transmission request message to request a transmission of ESG data corresponding to the designated ESG support language, transmits the created ESG data transmission request message to the digital broadcasting device 101 via the Internet communication network 107, and proceeds to step 1709.

When the digital broadcasting device 101 and the terminal 103 provide a digital broadcasting service according to OMA-BCAST standards, an ESG data transmission request message can be created, which includes a key-value pair format for requesting a transmission of ESG data corresponding to a specific language, as shown in FIG. 13.

In step 1709, upon receiving the ESG data transmission request message, the digital broadcasting device 101 analyzes the received ESG data transmission request message to identify the designated ESG support language. The digital broadcasting device 101 detects ESG data supporting the same language as the designated ESG support language from the stored ESG data, and proceeds to step 1711.

In step 1711, the digital broadcasting device 101 transmits the detected ESG data to the terminal 103 via the Internet communication network 107. In step 1713, the terminal 103 receives and stores the ESG data. The ESG data received by the terminal 103 refers to ESG data supporting the same language as the ESG support language designated by the user.

As such, the terminal 103 can transmit a request for a transmission of ESG data supporting a specific language to the digital broadcasting device 101 via the Internet communication network 107. In response to the request, the digital broadcasting device 101 transmits ESG data supporting the specific language to the terminal 103 via the Internet communication network 107.

Although, in the above description of the present invention, the terminal 103 receives ESG data supporting only one specific language, the terminal 103 can receive ESG data supporting more than one specific language, at the user's request.

In addition, in the above description, the terminal 103 transmits an ESG transmission request message to the digital broadcasting device 101 to request a transmission of ESG data supporting a specific language, and then receives only ESG data supporting the specific language in response to the message. However, the terminal 103 may transmit an ESG transmission request message to the digital broadcasting device 101 to request a transmission of ESG data satisfying at least one specific condition selected from a specific genre, a specific time period, and a specific digital broadcasting service, besides the specific language, and then receive ESG data satisfying the corresponding condition in response to the message. Particularly, the terminal 103 can transmit an ESG transmission request message to the digital broadcasting device 101 to request a transmission of ESG data corresponding to a specific language and a specific genre, and then receive ESG data supporting the specific language among ESG data related to the specific genre in response to the message.

As such, the digital broadcasting device according to the present invention classifies ESG data into ESG data bursts for each ESG support language and broadcasts the ESG data bursts so that the terminal is provided with ESG data bursts supporting a specific language.

In addition, the terminal according to the present invention can solely receive ESG data bursts corresponding to a language desired by the user. This shortens the time to receive ESG data.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for transmitting, by a digital broadcasting device in a digital video broadcasting system, an ESG (Electronic Service Guide), the method comprising the steps of:
creating ESG data bursts by grouping ESG data supporting a plurality of languages for each ESG support language;
establishing sessions corresponding to respective ESG data bursts;
creating ESG setting data comprising session information and ESG grouping criteria information, the session information comprising IP (Internet Protocol) addresses and port numbers corresponding to the entire sessions, respectively, the ESG grouping criteria information indicating that the ESG data bursts are grouped for each ESG support language; and
broadcasting the ESG setting data via a specific session and broadcasting the ESG data bursts via the established sessions.

2. The method as claimed in claim 1, wherein the ESG setting data is a partition declaration defined according to CBMS (Convergence of Broadcast and Mobile Services) standards.

3. The method as claimed in claim 2, wherein the partition declaration indicates the ESG grouping criteria information by using field identifiers, field encodings, start field values, and end field values corresponding to the established sessions, respectively.

4. The method as claimed in claim 3, wherein creating the ESG setting data comprises:
searching for a field identifier, a field encoding, a start field value, and an end field value corresponding to a specific session among the established sessions within the partition declaration;
setting the searched field identifier and the field encoding as values indicating that specific ESG data bursts broadcast via the specific session are grouped with regard to a specific support language;
setting the searched start field value and the end field value as values indicating the specific support language; and
repeating the searching and setting steps until field identifiers, field encodings, start field values, and end field values corresponding to the established sessions are set, respectively.

5. The method as claimed in claim 4, wherein the values indicating that the specific ESG data bursts are grouped with regard to a specific support language are set as: field_identifier==0×00, field_encoding ==0×0402,
wherein field_identifier holds a field identifier value and field_encoding holds a field encoding value.

6. The method as claimed in claim 4, wherein the values indicating the specific support language are set according to IETF (Internet Engineering Task Force) RFC (Request For Comments) 3066.

7. The method as claimed in claim 1, wherein the ESG setting data comprises DescriptionEntries defined according to OMA (Open Mobile Alliance)-BCAST (Mobile Broadcast Services Enabler Suite) standards.

8. The method as claimed in claim 7, wherein each DescriptionEntry indicates the ESG grouping criteria information by setting a LanguageCriteria element within a GroupingCriteria element, the GroupingCriteria element being a lower element of a DescriptionEntry element corresponding to a specific session among the established sessions, and the LanguageCriteria element indicates that specific ESG data bursts broadcast via the specific session are grouped with regard to a specific support language.

9. The method as claimed in claim 8, wherein the step of creating the ESG setting data comprises:
searching for a DescriptionEntry element corresponding to a specific session among the DescriptionEntry elements corresponding to the established sessions, respectively;
searching for a GroupingCriteria element, the GroupingCriteria element being a lower element of the searched DescriptionEntry element, and setting the LanguageCriteria element, the LanguageCriteria element being a lower element of the searched GroupingCriteria element; and
repeating the searching and setting steps until the LanguageCriteria elements corresponding to the established sessions are set, respectively.

10. The method as claimed in claim 9, wherein the LanguageCriteria element is defined as follows:
<xs:element name=“LanguageCriteria” type=“xs:language” minOccurs=“0”/>
wherein the LanguageCriteria indicates that the specific ESG data bursts are grouped with regard to a specific support language, and the xs:language is set as a value indicating the specific support language.

11. The method as claimed in claim 10, wherein the value indicating the specific support language is set according to IETF (Internet Engineering Task Force) RFC 3066.

12. A method for receiving an ESG (Electronic Service Guide) by a terminal in a digital video broadcasting system, the method comprising the steps of:
designating, by a user, an ESG support language;
receiving ESG setting data comprising session information and ESG grouping criteria information from a digital broadcasting device, the session information indicating IP (Internet Protocol) addresses and port numbers corresponding to entire sessions, the ESG grouping criteria information indicating that ESG data bursts are grouped for each ESG support language;
identifying a session used to broadcast a specific ESG data burst supporting a language identical to the designated ESG support language by analyzing the ESG setting data; and
receiving the specific ESG data burst via the identified session and storing the received ESG data burst.

13. The method as claimed in claim 12, wherein the ESG setting data is a partition declaration defined according to CBMS (Convergence of Broadcast and Mobile Services) standards.

14. The method as claimed in claim 13, wherein the partition declaration indicates the ESG grouping criteria information by using field identifiers, field encodings, start field values, and end field values corresponding to respective sessions used to broadcast ESG data bursts grouped for each ESG support language.

15. The method as claimed in claim 14, wherein identifying the session comprises:
searching for a field identifier, a field encoding, a start field value, and an end field value corresponding to a specific session among the entire sessions by analyzing the partition declaration; and
identifying the specific session by using the session information when the searched field identifier and field encoding are values indicating that the specific ESG data bursts are grouped with regard to a specific support language and when the searched start field value and end field value are values indicating the designated ESG support language.

16. The method as claimed in claim 15, further comprising repeating the searching and identifying steps when the searched field identifier and field encoding are not values indicating that the specific ESG data bursts are grouped with regard to a specific support language or when the searched start field value and end field value are not values indicating the designated ESG support language.

17. The method as claimed in claim 15, wherein the values indicating that the specific ESG data bursts are grouped with regard to a specific support language is set as: field_identifier==0×02, field_encoding==0×0402,
wherein field_identifier holds a field identifier value and field_encoding holds a field encoding value.

18. The method as claimed in claim 15, wherein the values indicating the specific support language are set according to IETF (Internet Engineering Task Force) RFC (Request For Comments) 3066.

19. The method as claimed in claim 12, wherein the ESG setting data comprise DescriptionEntry elements defined according to OMA (Open Mobile Alliance)-BCAST (mobile Broadcast Services Enabler Suite) standards.

20. The method as claimed in claim 19, wherein respective DescriptionEntry elements indicate the ESG grouping criteria information by setting LanguageCriteria elements within GroupingCriteria elements, the GroupingCriteria elements being lower elements of DescriptionEntry elements corresponding to respective sessions used to broadcast ESG data bursts grouped for each ESG support language, and respective LanguageCriteria elements indicate that each of the grouped ESG data bursts is grouped with regard to a specific support language.

21. The method as claimed in claim 20, wherein identifying the session comprises:
searching for a GroupingCriteria element by analyzing a specific DescriptionEntry element among entire DescriptionEntry elements and searching for a LanguageCriteria element by analyzing the searched GroupingCriteria element; and
identifying the specific session by using the session information when a value set in the searched LanguageCriteria element to indicate that a language is identical to a value indicating the designated ESG support language.

22. The method as claimed in claim 21, further comprising repeating the searching and identifying steps when the value set in the searched LanguageCriteria element to indicate a language is not identical to the value indicating the designated ESG support language.

23. The method as claimed in claim 21, wherein the LanguageCriteria elements is defined as:
<xs:element name=“LanguageCriteria” type=“xs:language” minOccurs=“0”/>,
wherein the LanguageCriteria indicates that the specific ESG data bursts are grouped with regard to a specific support language, and the xs:language is set as a value indicating the specific support language.

24. The method as claimed in claim 23, wherein the value indicating the specific support language is defined according to IETF (Internet Engineering Task Force) RFC (Request For Comments) 3066.

25. A method for transmitting an ESG (Electronic Service Guide) by a digital broadcasting device in a digital video broadcasting system, the method comprising the steps of:
receiving an ESG transmission request message from a terminal via an Internet communication network, the message requesting a transmission of an ESG data burst supporting a specific language, and analyzing the received ESG transmission request message to identify the specific language;
retrieving an ESG data burst supporting the identified specific language from pre-stored ESG data supporting a plurality of languages; and
transmitting the retrieved ESG data burst to the terminal via the Internet communication network.

26. The method as claimed in claim 25, wherein the Internet communication network is based on HTTP (HyperText Transfer Protocol)/1.1.

27. The method as claimed in claim 25, wherein, when the digital video broadcasting system provides a digital broadcasting service according to OMA (Open Mobile Alliance)-BCAST (Mobile Broadcast Services Enabler Suite) standards, the ESG transmission request message comprises a key-value pair format defined as:
<key>: “language”, and
<value>: a value indicating an ESG support language.

28. The method as claimed in claim 27, wherein the value indicating the ESG support language is defined according to IETF (Internet Engineering Task Force) RFC (Request For Comments) 3066.

29. A method for receiving, by a terminal in a digital video broadcasting system, an ESG (Electronic Service Guide), the method comprising the steps of:
designating an ESG support language by a user;
creating an ESG transmission request message requesting a transmission of an ESG data burst supporting a language identical to the designated ESG support language;
transmitting the created ESG transmission request message to a digital broadcasting device via an Internet communication network; and
receiving and storing the ESG data burst from the digital broadcasting device via the Internet communication network in response to the transmitted ESG transmission request message.

30. The method as claimed in claim 29, wherein the Internet communication network is based on HTTP (HyperText Transfer Protocol)/1.1.

31. The method as claimed in claim 29, wherein, when the digital video broadcasting system provides a digital broadcasting service according to OMA (Open Mobile Alliance)-BCAST (Mobile Broadcast Services Enabler Suite) standards, the ESG transmission request message comprises a key-value pair format defined:
<key>: “language”, and
<value>: a value indicating an ESG support language.

32. The method as claimed in claim 31, wherein the value indicating the ESG support language is defined according to IETF (Internet Engineering Task Force) RFC (Request For Comments) 3066.

33. An apparatus for transmitting an ESG (Electronic Service Guide) by a digital broadcasting device in a digital video broadcasting system, the apparatus comprising:
an ESG setting unit for creating ESG data bursts by grouping ESG data supporting a plurality of languages for each ESG support language, establishing sessions corresponding to respective ESG data bursts, and creating ESG setting data comprising session information and ESG grouping criteria information, the session information comprising IP (Internet Protocol) addresses and port numbers corresponding to the established sessions, the ESG grouping criteria information indicating that the ESG data bursts are grouped for each ESG support language;
an encapsulation unit for encapsulating the ESG data bursts and the ESG setting data;
a multiplexing unit for creating a transport stream by using the encapsulated ESG data bursts and the encapsulated ESG setting data according to the established sessions; and
a modulation unit for receiving an input of the transport stream and broadcasting the transport stream.

34. The apparatus as claimed in claim 33, wherein the ESG setting data is a partition declaration defined according to CBMS (Convergence of Broadcast and Mobile Services) standards.

35. The apparatus as claimed in claim 34, wherein the partition declaration indicates the ESG grouping criteria information by using field identifiers, field encodings, start field values, and end field values corresponding to the established sessions, respectively.

36. The apparatus as claimed in claim 34, wherein, when the ESG setting data is created, the ESG setting unit searches for a field identifier, a field encoding, a start field value, and an end field value corresponding to a specific session among the established sessions, sets the searched field identifier and field encoding as values indicating that specific ESG data bursts corresponding to the specific session are grouped with regard to a specific support language, sets the searched start field value and end field value as values indicating the specific support language, and repeatedly searches for and sets the field identifier, field encoding, start field value, and end field value until field identifiers, field encodings, start field values, and end field values corresponding to the established sessions are set, respectively.

37. The apparatus as claimed in claim 36, wherein the values indicating that the specific ESG data bursts are grouped with regard to a specific support language are set as: field_identifier==0×02, field_encoding==0×0402,
wherein field_identifier holds a field identifier value and field_encoding holds a field encoding value.

38. The apparatus as claimed in claim 36, wherein the values indicating the specific support language are set according to IETF (Internet Engineering Task Force) RFC (Request For Comments) 3066.

39. The apparatus as claimed in claim 33, wherein the ESG setting data comprises DescriptionEntries defined according to OMA (Open Mobile Alliance)-BCAST (Mobile Broadcast Services Enabler Suite) standards.

40. The apparatus as claimed in claim 39, wherein each DescriptionEntry indicates the ESG grouping criteria information by setting a LanguageCriteria element within a GroupingCriteria element, the GroupingCriteria element being a lower element of a DescriptionEntry element corresponding to a specific session among the established sessions, and the LanguageCriteria element indicates that specific ESG data bursts broadcast via the specific session are grouped with regard to a specific support language.

41. The apparatus as claimed in claim 40, wherein, when the ESG setting data is created, the ESG setting unit searches for GroupingCriteria elements corresponding to the established sessions, respectively, and sets the LanguageCriteria elements within the searched GroupingCriteria elements.

42. The apparatus as claimed in claim 41, wherein the LanguageCriteria element is defined as:
<xs:element name=“LanguageCriteria” type=“xs:language” minOccurs=“0”/>,
wherein the LanguageCriteria indicates that the specific ESG data bursts are grouped with regard to a specific support language, and the xs:language is set as a value indicating the specific support language.

43. The apparatus as claimed in claim 42, wherein the value indicating the specific support language is defined according to IETF (Internet Engineering Task Force) RFC (Request For Comments) 3066.

44. An apparatus for receiving, by a terminal in a digital video broadcasting system, an ESG (Electronic Service Guide), the apparatus comprising:
a memory unit;
a wireless unit; and
a control unit for designating an ESG support language by a user, receiving ESG setting data from a digital broadcasting device by using the wireless unit, the ESG setting data comprising session information and ESG grouping criteria information, the session information indicating IP (Internet Protocol) addresses and port numbers corresponding to entire sessions, respectively, the ESG grouping criteria information indicating that ESG data bursts are grouped for each ESG support language, analyzing the received ESG setting data to identify a session used to broadcast a specific ESG data burst supporting a language identical to the designated ESG support language, receiving the specific ESG data burst via the identified session, and storing the received ESG data burst in the memory unit.

45. The apparatus as claimed in claim 44, wherein the ESG setting data is a partition declaration defined according to CBMS (Convergence of Broadcast and Mobile Services) standards.

46. The apparatus as claimed in claim 45, wherein the partition declaration indicates the ESG grouping criteria information by using field identifiers, field encodings, start field values, and end field values corresponding to the established sessions, respectively.

47. The apparatus as claimed in claim 46, wherein, when the session is identified, the control unit searches for a field identifier, a field encoding, a start field value, and an end field value corresponding to a specific session among the entire sessions by analyzing the partition declaration, and the control unit identifies the specific session by using the session information when the searched field identifier and field encoding are values indicating that the specific ESG data bursts are grouped with regard to a specific support language and when the searched start field value and end field value are values indicating the designated ESG support language.

48. The apparatus as claimed in claim 47, wherein, when the searched field identifier and field encoding are not values indicating that specific ESG data bursts are grouped with regard to a specific support language, the control unit searches for a field identifier and a field encoding corresponding to a different session among the established sessions.

49. The apparatus as claimed in claim 47, wherein, when the searched start field value and end field value are not identical to values indicating the designated ESG support language, the control unit searches for a field identifier and a field encoding corresponding to a different session among the established sessions.

50. The apparatus as claimed in claim 47, wherein the values indicating that the specific ESG data busts are grouped with regard to a specific support language are values setting the field identifier and field encoding as 0×02 and 0×0402, respectively.

51. The apparatus as claimed in claim 47, wherein the values indicating the specific support language are defined according to IETF (Internet Engineering Task Force) RFC (Request For Comments) 3066.

52. The apparatus as claimed in claim 45, wherein the ESG setting data comprises DescriptionEntry elements defined according to OMA (Open Mobile Alliance)-BCAST (Mobile Broadcast Services Enabler Suite) standards.

53. The apparatus as claimed in claim 52, wherein each DescriptionEntry element indicates the ESG grouping criteria information by setting a LanguageCriteria element within a GroupingCriteria element, the GroupingCriteria element being a lower element of a DescriptionEntry element corresponding to a specific session among the established sessions, and the LanguageCriteria element indicates that specific ESG data bursts broadcast via the specific session are grouped with regard to a specific support language.

54. The apparatus as claimed in claim 53, wherein, when the session is identified, the control unit searches for a GroupingCriteria element corresponding to a specific session among the sessions, searches for a LanguageCriteria element, the LanguageCriteria element being a lower element of the searched GroupingCriteria element, determines whether a value set in the searched LanguageCriteria element to indicate a language of a specific ESG data burst is identical to a value indicating the designated ESG support language, and identifies the specific session by using the session information when the value indicating the language of the specific ESG data burst is identical to the value indicating the designated ESG support language.

55. The apparatus as claimed in claim 54, wherein, when the value indicating the language of the specific ESG data burst is not identical to the value indicating the designated ESG support language, the control unit searches for a LanguageCriteria element corresponding to a different session among the sessions.

56. The apparatus as claimed in claim 54, wherein the LanguageCriteria elements is defined as:
<xs:element name=“LanguageCriteria” type=“xs:language” minOccurs=“0”/>,
wherein, the LanguageCriteria indicates that the specific ESG data bursts are grouped with regard to a specific support language, and the xs:language is set as a value indicating the specific support language.

57. The apparatus as claimed in claim 54, wherein the value indicating the specific support language is defined according to IETF (Internet Engineering Task Force) RFC (Request For Comments) 3066.

58. An apparatus for transmitting an ESG (Electronic Service Guide) by a digital broadcasting device in a digital video broadcasting system, the apparatus comprising:
a wireless unit for communicating with a terminal via an Internet communication network;
an ESG storage unit for storing ESG data supporting a plurality of languages; and
an ESG selection unit for receiving an ESG transmission request message via the wireless unit, the message requesting a transmission of ESG data bursts supporting a specific language, analyzing the received ESG transmission request message to identify the specific language, retrieving an ESG data burst supporting the identified specific language from the ESG data, and transmitting the retrieved ESG data burst to the terminal via the wireless unit.

59. The apparatus as claimed in claim 58, wherein the Internet communication network is based on HTTP (HyperText Transfer Protocol)/1.1.

60. The apparatus as claimed in claim 58, wherein, when the digital video broadcasting system provides a digital broadcasting service according to OMA (Open Mobile Alliance)-BCAST (Mobile Broadcast Services Enabler Suite) standards, the ESG transmission request message comprises a key-value pair format defined as:
<key>: “language”, and
<value>: a value indicating an ESG support language.

61. The apparatus as claimed in claim 60, wherein the value indicating the ESG support language is defined according to IETF (Internet Engineering Task Force) RFC (Request For Comments) 3066.

62. An apparatus for receiving an ESG (Electronic Service Guide)by a terminal in a digital video broadcasting system, the apparatus comprising:
a wireless unit for communicating with a digital broadcasting device via an Internet communication network;
a memory unit; and
a control unit for designating an ESG support language by a user, creating an ESG transmission request message for requesting a transmission of ESG data bursts supporting a language identical to the designated ESG support language, transmitting the created ESG transmission request message to the digital broadcasting device via the wireless unit, receiving ESG data bursts from the digital broadcasting device via the wireless unit in response to the transmitted message, and storing the received ESG data bursts in the memory unit.

63. The apparatus as claimed in claim 62, wherein the Internet communication network is based on HTTP (HyperText Transfer Protocol)/1.1.

64. The apparatus as claimed in claim 62, wherein, when the digital video broadcasting system provides a digital broadcasting service according to OMA (Open Mobile Alliance)-BCAST (Mobile Broadcast Services Enabler Suite) standards, the ESG transmission request message comprises a key-value pair format defined as:
<key>: “language”, and
<value>: a value indicating an ESG support language.

65. The apparatus as claimed in claim 64, wherein the value indicating the ESG support language is defined according to IETF (Internet Engineering Task Force)RFC (Request For Comments) 3066.
